(19) United States
(12) Patent Application Publication
(10) Pub. No.: US 2011/0014825 A1
(43) Pub. Date: Jan. 20, 2011

(54) ELECTRICAL TERMINAL CONNECTION WITH GALVANIC SACRIFICIAL METAL

(75) Inventors: GEORGE ALBERT DREW, WARREN, OH (US); MARK A. SCHEEL, CANFIELD, OH (US)

Correspondence Address: Delphi Technologies, Inc., M/C 480-410-202, P.O. Box 5052, Troy, MI, 48007, US

(73) Assignee: DELPHI TECHNOLOGIES, INC., TROY, MI (US)

(21) Appl. No.: 12/716,431

(22) Filed: Mar. 3, 2010

Related U.S. Application Data
(60) Provisional application No. 61/225,960, filed on Jul. 16, 2009.

(51) Int. Cl. H01R 4/10

(52) U.S. Cl. 439/877

(57) ABSTRACT

An electrical terminal has a copper-based body and a coating disposed on at least a portion of a surface of the body. The coating is a metal selected from a group consisting of zinc, magnesium, a zinc alloy, magnesium alloy or other metal that is more electronegative than aluminum and its alloys.

### CROSS REFERENCE TO RELATED APPLICATION

This is a United States regular utility patent application filed pursuant to 35 U.S.C. §111(a) and claiming the benefit of the priority under 35 U.S.C. §119(e)(1) of U.S. Provisional Application Ser. No. 61/225,960 filed Jul. 16, 2009, such provisional application being incorporated by reference.

### TECHNICAL FIELD

The field of this invention relates to a connection between an aluminum-based electric cable and a copper-based electrical terminal.

### BACKGROUND OF THE DISCLOSURE

Insulated copper-based cable is commonly used for automotive wiring. Copper has high conductivity, good corrosion resistance and adequate structural strength. However, copper and copper-based metals are relatively expensive and are also heavy compared to other metals, for example aluminum.

Interest in weight savings and cost savings for automotive electrical wiring applications has made aluminum-based cables or wires an attractive alternative to copper-based cables or wires; some wiring and electrical connectors, however, may remain copper-based. Thus, there may be a transition somewhere in the electrical circuit between an aluminum-based portion of the circuit and a copper-based portion of the circuit. This transition commonly occurs between an aluminum-based cable and a copper-based terminal. The terminal often remains copper-based because copper-based material can be worked to achieve more complex shapes than aluminum-based materials. The interface between aluminum-based cable to a copper-based terminal can produce a galvanic corrosion of the aluminum, if an electrolyte, for example salt water, is present. The galvanic reaction corrodes the aluminum because the aluminum or aluminum alloy has a different galvanic potential than the copper or copper alloys of the terminals. “Copper-based” as used in this document means pure copper, or a copper alloy where copper is the main metal in the alloy. Similarly, “aluminum-based” as used in this document means pure aluminum or an aluminum alloy where aluminum is a main metal in the alloy. “Zinc-based” as used in this document means pure zinc or a zinc alloy where zinc is a significant portion of the alloy. “Magnesium-based” as used in this document means pure magnesium or a magnesium alloy where magnesium is a significant portion of the alloy.

Referring now to FIG. 1, significant corrosion is known to occur between dissimilar materials when an electrolyte such as salt water is present. A conventional copper-based terminal 11 as shown in FIG. 1 has a pair of insulator wings 26 and several pairs of core wings 20. A stranded aluminum-based cable 12 may have its connected exposed strand ends 15 of lead 16 substantially corrode when it is attached to a terminal 35 made from a more noble metal such as pure copper, brass or other copper alloy. A four day long salt fog test has been demonstrated to substantially corrode away almost the entire aluminum lead 16 as illustrated. The lead 16 when corroded completely away causes a break in the electrical connection between the cable 12 and the terminal 35.

It has long been known to apply grease to cover the interface between a cable and a terminal. However, grease has been shown to be an ineffective preventative in the long term under harsh automotive environments where salt sprays and wind pressures can easily wear away at the grease and expose the crimp interface. In the case of an aluminum and copper interface, even a small amount of exposed aluminum cable can contribute to significant galvanic corrosion.

Other conformal coatings have been applied over the terminal and cable after assembly to seal the terminal connections from ambient electrolytes. However, the conformal coatings are only effective when they completely cover the otherwise exposed metal and are free of cracks and gaps.

What is needed is a connection between aluminum-based cable and copper-based terminals with improved corrosion resistance for greater usable endurance in spite of any breaks or openings in the seal about the terminal.

### SUMMARY OF THE DISCLOSURE

In accordance with one aspect of the invention, an electrical terminal has a copper-based body and a metal coating disposed on at least a portion of a surface of the body. The metal coating is selected from a group consisting of zinc, magnesium, a zinc alloy, a magnesium alloy or other metal that is more electronegative than aluminum and its alloys. Preferably, the coating has at least one electroplated layer on the copper-based body. In one embodiment, the coating is a cladding secured onto the body. In another embodiment, the body has a pair of crimp wings constructed to crimp onto an aluminum-based electrical wire. It is preferred that the crimp wings have a contact area being free of the coating to be able to have direct electrical contact of the copper-based body with the aluminum-based electrical wire.

In accordance with another aspect of the invention, an electrical connection structure has a conductive aluminum-based wire, a copper-based terminal electrically attached to the wire and a galvanic sacrificial material electrically connected to the terminal that is more electro-negative when exposed to salt water than the conductive aluminum-based wire. The galvanic sacrificial material is located remotely from the terminal body and is electrically connected thereto. The electrical connection structure is preferably covered by a protective conformal coating as a primary system to prevent corrosion. The galvanic sacrificial material is used as a secondary back up system to prevent corrosion if there is a break in the integrity of the protective conformal coating.

Preferably, the galvanic sacrificial material is selected from a group consisting of zinc, magnesium, a zinc alloy and a magnesium alloy. The sacrificial material is a coating covering at least a portion of a surface of the terminal. In one embodiment, the terminal has a pair of crimp wings constructed to crimp onto an aluminum-based electrical wire. The crimp wings have a contact section being free of the coating to have direct electrical contact with the aluminum-based wire when crimped thereon.

In another embodiment, the terminal surface has a contact area that is substantially free of the coating to have direct electrical contact with the aluminum-based electrical wire.

According to another aspect of the invention, a corrosion resistant electrical connection structure has an electrically conductive wire made of a first electrically conductive material. A terminal is electrically connected to the wire. The terminal is made from a second electrically conductive material that is more electro-positive than the first electrically conductive material when exposed to a salt water environment. A sacrificial coating is disposed on at least a portion of a surface of the terminal. The sacrificial coating is more electro-negative than the first electrically conductive material when exposed to a salt water environment.

### BRIEF DESCRIPTION OF THE DRAWINGS

Reference now is made to the accompanying drawings in which:

FIG. 1 illustrates a conventional aluminum-based cable and copper-based terminal shown after four days of a salt-fog test showing the exposed stranded end of the aluminum-based wire being substantially corroded away;

FIG. 2 illustrates an aluminum-based cable and a copper-based terminal with a tin-zinc electroplated coating shown after four days of the same salt-fog test that the conventional cable and terminal connection shown in FIG. 1 underwent illustrating very little corrosion in comparison;

FIG. 3 is a perspective view of copper-based terminal with a tin coating and a zinc-based coating over one portion of the terminal;

FIG. 4 is a cross-sectional view of the terminal taken along line 4-4 as shown in FIG. 3; and

FIG. 5 is a schematic illustration showing sacrificial metal positioned at a remote location from the cable terminal connection and having a conformal coating sealing the terminal connection.

### DETAILED DESCRIPTION OF THE PREFERRED EMBODIMENT

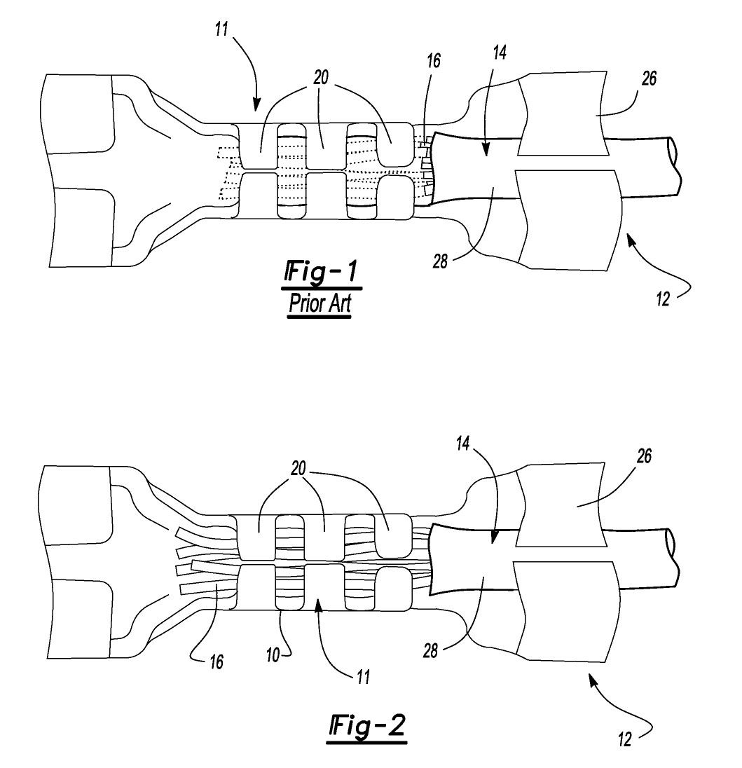

Referring to FIG. 2, a tin-zinc electroplated coating 10 can be applied to a copper-based electrical terminal 12 that is conventionally crimped to a stranded aluminum-based cable 14 to form electrical connection structure 11. The terminals were subjected to a salt-fog for four days to test the resistance to galvanic corrosion. Very little corrosion is shown either on the terminal with the tin-zinc plating or the exposed stranded wire ends 16 of the aluminum-based cable 14. This reduced corrosion level is a great improvement over the corroded connection shown in FIG. 1 that has the same construction minus the tin-zinc electroplating and underwent the same salt-fog test. Other methods such as a thermal spray or kinetic spray can be used to apply the tin-zinc to the terminal.

Significant improvement in galvanic corrosion resistance of aluminum-based cable connection to copper-based electrical terminals occurs by adding the tin-zinc coating to electrical terminals. The zinc addition reduces the galvanic potential between the copper-based electrical terminals and aluminum-based cable which in turn significantly reduces the corrosion rate.

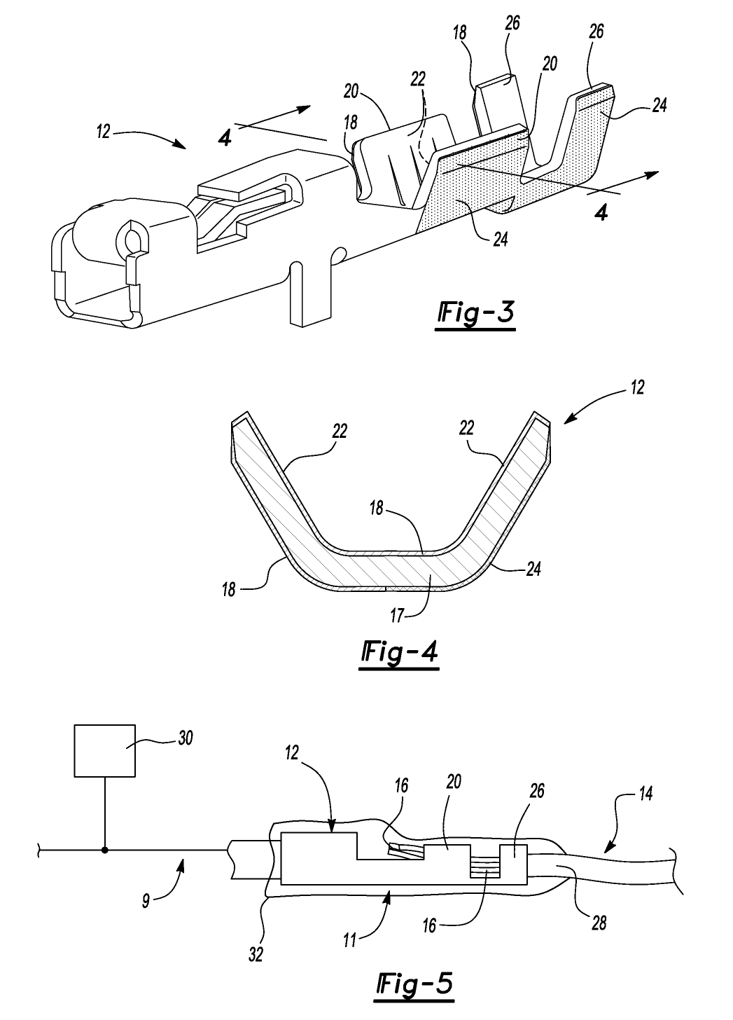

While a tin-zinc coating 10 is illustrated, pure zinc or other zinc alloys may be used. Furthermore, magnesium may also substitute for the zinc in the form of a magnesium alloy or pure magnesium. Furthermore, while a thin electroplated or sprayed layer applied overall to the electrical terminal is used to introduce the zinc-based or magnesium-based material to the terminal, other methods to add zinc or magnesium-based material may be used, such as adding a clad inlay containing zinc and/or magnesium to the electrical terminal. One such selective clad section is shown in FIGS. 3 and 4 which show a terminal 12 with a copper-based core 17 having a tin coating 18 and a section of zinc-based plating 24 at the crimping wings 20 of the terminal 12. The zinc-based plating 24 may extend to the retainer crimp flange 26 that hold the aluminum cable about its outer insulating layer 28.

Referring now to FIGS. 3 and 4, it is foreseen to selectively coat or add zinc or magnesium to the terminal such that the wings 20 when crimped allow direct contact of the tin plating 18 to the exposed aluminum stranded end 16. In other words, there is a contact area 22 that is substantially free of the zinc-based or magnesium-based coating. In other words, the aluminum is in direct contact with the tin plated copper and any corrosion due to the zinc or magnesium material will not interfere with the continuity of the electrical contact at the contact area.

Because copper, brass or other copper alloy terminals do not corrode as fast as zinc or magnesium, it may thus appear counterintuitive to add zinc or magnesium to a copper alloy terminal. However, the zinc or magnesium is used as a sacrificial metal to preserve the aluminum cable against corrosion. By placing the zinc or magnesium in the electric circuit, galvanic reactions will sacrifice the zinc or magnesium before the aluminum corrodes at the aluminum cable-copper terminal interface.

Referring now to FIG. 5, it is also foreseeable to place the zinc-based or magnesium-based material 30 at a remote location away from the cable-terminal connection 11 as long as the zinc-based or magnesium-based material 30 is electrically connected to the electric circuit 9.

It is also foreseen to use the zinc or magnesium as a second redundant system to reduce corrosion. For example the primary system to reduce corrosion may be a conformal coating 32 that encapsulates and seals the cable and terminal from outside elements such as salt water and other electrolytic carrying materials. The zinc-based and magnesium-based material thus only become active as a sacrificial metal when the conformal coating integrity is compromised and cracks or leaks occur to allow salt water or other electrolyte to come into contact with the exposed cable ends or terminal. The conformal coating 32 can also be applied to the first embodiment shown in FIGS. 2-4.

Zinc-based and magnesium-based metals are preferred due to their common availability. However, other metals more electronegative than aluminum and its alloys are also foreseen to be viable alternatives. Less common metals, for example, chromium and beryllium also work as a sacrificial metal.

Other variations and modifications are possible without departing from the scope and spirit of the present invention as defined by the appended claims.

1. An electrical terminal comprising:
a body being copper-based; and
a coating disposed on at least a portion of the body, said coating being a metal selected from a group consisting of zinc, magnesium, a zinc alloy, a magnesium alloy or other metal that is more electronegative than aluminum and its alloys.

2. An electrical terminal as defined in claim 1 further comprising:
said coating being an electroplated layer on said body.

3. An electrical terminal as defined in claim 1 further comprising:
said coating being a cladding secured onto said body.

4. An electrical terminal as defined in claim 1 further comprising:
said coating being a sprayed coating.

5. An electrical terminal as defined in claim 1 further comprising:
said body having a pair of crimp wings constructed to crimp onto an aluminum-based electrical wire.

6. An electrical terminal as defined in claim 1 further comprising:
said crimp wings having a contact section being free of said coating.

7. An electrical terminal as defined in claim 6 further comprising:
said contact section having an outer tin plating thereon.

8. A corrosion resistant electrical connection structure comprising:
an electrically conductive wire made of a first electrically conductive material;
a terminal electrically connected to the wire, the terminal being made of a second electrically conductive material that is more electro-positive than the first electrically conductive material when exposed to a salt water environment; and
a galvanic sacrificial material electrically connected to the terminal being more electro-negative when exposed to salt water than the first electrically conductive material.

9. An electrical connection structure as defined in claim 8 further comprising:
said conductive wire being aluminum-based;
said terminal being copper-based; and
a galvanic sacrificial material electrically connected to the terminal being more electro-negative when exposed to salt water than said conductive aluminum-based wire.

10. An electrical connection structure as define in claim 9 further comprising:
said galvanic sacrificial material being selected from a group consisting of zinc, magnesium, a zinc alloy and a magnesium alloy.

11. An electrical connection structure as define in claim 10 further comprising:
said galvanic sacrificial material being a coating covering at least a portion of a surface of the terminal.

12. An electrical connection structure as define in claim 11 further comprising:
said terminal having a pair of crimp wings constructed to crimp onto an aluminum-based electrical wire; and
said crimp wings having a contact section being free of said coating.

13. An electrical connection structure as defined in claim 11 further comprising:
said contact section having an outer tin plating thereon.

14. An electrical connection structure as define in claim 9 further comprising:
said galvanic sacrificial material being located remote from said terminal body and electrically connected thereto.

15. An electrical connection structure as define in claim 14 further comprising:
a protective conformal coating as a primary system to prevent corrosion with said galvanic sacrificial material being used as a secondary back up system to prevent corrosion.

16. An electrical connection structure as define in claim 10 further comprising:
a protective conformal coating as a primary system to prevent corrosion with said galvanic sacrificial material being used as a secondary back up system to prevent corrosion.

17. An electrical connection structure as define in claim 8 further comprising:
said galvanic sacrificial material being located remote from said terminal and electrically connected thereto.

18. An electrical connection structure as define in claim 8 further comprising:
a protective conformal coating as a primary system to prevent corrosion with said galvanic sacrificial material being used as a secondary back up system to prevent corrosion.
